(19) United States
(12) Patent Application Publication
(10) Pub. No.: US 2026/0061492 A1
(43) Pub. Date: Mar. 5, 2026

(54) Additive Manufacturing Device and Method with Interlayer Ultrasonic Rolling Assisted Through in-situ Electromagnetic Induction Heating

(71) Applicant: Xi'an Jiaotong University, Xi'an City (CN)

(72) Inventors: Ke HUANG, Xi'an (CN); Xinzhi LI, Xi'an (CN); Mugong ZHANG, Xi'an (CN); Xuewei FANG, Xi'an (CN); Bingheng LU, Xi'an (CN)

(21) Appl. No.: 19/316,820

(22) Filed: Sep. 2, 2025

(30) Foreign Application Priority Data
Sep. 2, 2024 (CN) 202411221465X

(51) Int. Cl. B22F 10/50; B22F 3/18; B22F 10/28; B22F 10/31; B33Y 10/00; B33Y 30/00; B33Y 50/02

(52) U.S. Cl. CPC B22F 10/50; B22F 3/18; B22F 10/28; B22F 10/31; B22F 2003/185; B33Y 10/00; B33Y 30/00; B33Y 50/02

(57) ABSTRACT

An additive manufacturing device and method with interlayer ultrasonic rolling coupled in-situ electromagnetic induction heating, the device includes an additive manufacturing equipment, a substrate turntable for supporting and adjusting a component's position, an ultrasonic rolling device and an electromagnetic induction heating device cooperated with a top of the component; an ultrasonic controller connected to the ultrasonic rolling device to set rolling parameters required, and an electromagnetic controller connected to the electromagnetic induction heating device to set a current intensity and an induction frequency required. The device and method utilize eddy currents generated by an alternating electromagnetic field to regulate component surface temperature, which can significantly reduce ultrasonic rolling resistance, improve interlayer strengthening efficiency, reduce interlayer strengthening costs, broaden the range of materials suitable for interlayer strengthening, close defects in AM metal components and improve component forming quality and density, and has a positive impact on AM metal materials.

### CROSS REFERENCE OF RELATED APPLICATION

This is a non-provisional application which claimed priority of Chinese application number 202411221465X, filing date Sep. 2, 2024. The contents of the specification, including any intervening amendments thereto, are incorporated herein by reference.

### BACKGROUND OF THE PRESENT INVENTION

### Field of Invention

The present invention relates to metal additive manufacturing technology, and in particularly relates to an additive manufacturing device and method with interlayer ultrasonic rolling assisted by in-situ electromagnetic induction heating.

### Description of Related Arts

Additive Manufacturing (AM) uses wire materials or powder as raw materials and electric arc, electron beam or laser as heat source to print layer by layer according to the preset path of 3D model slice data. It has advantages of high efficiency and low cost and is expected to achieve the integrated forming of complex components. It has broad application prospects in high-end equipment fields such as aerospace, automobile, high-speed rail, and national defense and military industries. Due to the mismatch between the material properties of metals and process parameters, additively manufactured components often have non-uniform structures, metallurgical defects, and stress deformation, which greatly reduces their reliability and service life. It is difficult to meet the service requirements in the field of high-end equipment, and it is a bottleneck problem that needs to be overcome urgently. In response to the above bottleneck problem, although plastic deformation can be introduced on the weld surface by interlayer ultrasonic rolling at room temperature, which can close the pores and improve the microstructure and mechanical properties to a certain extent, there are still some shortcomings. First, the depth of the affected layer is shallow, the strengthening efficiency is low, and the strengthening effect is insufficient; second, it cannot process metal materials with large deformation resistance and poor plastic deformation ability, and the applicable material range is narrow.

The above information disclosed in this Background section is only for enhancement of understanding of the background of the invention and therefore it may contain information that does not form the prior art that is already known to a person skilled in the art.

### SUMMARY OF THE PRESENT INVENTION

In order to solve the above problems, the present invention provides an additive manufacturing device and method utilizing interlayer ultrasonic rolling coupled with in-situ electromagnetic induction heating to achieve precise temperature control during the ultrasonic rolling process, thereby expanding the types of applicable metal materials and further improving the improvement effect of interlayer strengthening.

In order to achieve the above object, the technical solution adopted by the present invention is as follows:

An additive manufacturing device and method with interlayer ultrasonic rolling coupled with in-situ electromagnetic induction heating, the device includes an additive manufacturing equipment for printing a component, a substrate turntable for supporting and adjusting position and posture of the component, an ultrasonic rolling device and an electromagnetic induction heating device cooperated with a top of the component; an ultrasonic controller connected to the ultrasonic rolling device to set rolling parameters required for the ultrasonic rolling device, and an electromagnetic controller connected to the electromagnetic induction heating device to set a current intensity and an induction frequency required for the electromagnetic induction heating device.

The additive manufacturing equipment is an arc fuse additive manufacturing device, a laser directed energy deposition device, or an electron beam directed energy deposition device.

The electromagnetic induction heating device is a disc-shaped electromagnetic induction copper tube.

The electromagnetic induction heating device and the ultrasonic rolling device are coaxially installed.

An additive manufacturing method with interlayer ultrasonic rolling assisted by in-situ electromagnetic induction heating includes the following steps:

Step (1): Create a 3D model of a component by using a computer CAD software, and perform slicing, layering and path planning of the 3D model of the component through an additive manufacturing system software to obtain a preset printing path.

Step (2): Print the component with the preset path by a print head of an additive manufacturing equipment, and adjust a position of the component through a substrate turntable to achieve printing, which may be of any shape.

Step (3): After printing one layer, regulate a current and an induction frequency of an electromagnetic induction heating device by an electromagnetic controller so that the electromagnetic induction heating device introduces a heating temperature required to an interlayer rolling area of the component; and set an ultrasonic power and frequency of an ultrasonic rolling device 6 by an ultrasonic controller 7 so that the ultrasonic rolling device introduces a plastic deformation zone of a desired depth in the interlayer. After the parameters are set, turn on the electromagnetic induction heating device and the ultrasonic rolling device at the same time to perform ultrasonic rolling on a latest printed layer.

Step (4): If a depth of the affected layer reaches the set range, repeat steps (2) to (3); if the depth of the affected layer is less than the required range, continue to adjust the parameters of the ultrasonic controller and the electromagnetic controller, and then repeat step (3).

Step (5): Repeat steps (2) to (4) until the entire component 3 is printed.

Compared to existing arts, the advantages of the present invention are:

1. Since the present invention adopts the method of interlayer ultrasonic rolling coupled with in-situ electromagnetic induction heating, the eddy current effect of electromagnetic induction is used for local heating to enhance the plastic deformation ability of the metal material and affect the depth of the layer. Compared with interlayer ultrasonic rolling at room temperature, it has the advantages of high strengthening efficiency and significant strengthening effect.

2. Since the present invention adopts the method of interlayer ultrasonic rolling coupled with in-situ electromagnetic induction heating, it can not only significantly reduce the deformation resistance of metal materials with large deformation resistance, but also significantly improve the deformation capacity of metal materials with poor room temperature plastic deformation, so it has the advantage of being applicable to a wide range of materials.

3. Since the present invention adopts the method of interlayer ultrasonic rolling coupled with in-situ electromagnetic induction heating, compared with interlayer ultrasonic rolling at room temperature, the in-situ tempering heat treatment can be performed by local electromagnetic induction heating. Therefore, it has the advantages of small residual thermal stress and deformation.

The above description is only an overview of the technical solution of the present invention. In order to make the technical means of the present invention more clear and understandable for those skilled in the art to implement the present invention according to the contents of the description, and to make the above and other purposes, features and advantages of the present invention more obvious and easy to understand, the following specific embodiments of the present invention are illustrated.

### BRIEF DESCRIPTION OF THE DRAWINGS

Various other advantages and benefits of the present invention will become apparent to those skilled in the art upon reading the detailed description of the preferred embodiments below. The drawings in this specification are intended only to illustrate preferred embodiments and are not to be construed as limiting the present invention. Obviously, the figures described below represent only some embodiments of the present invention; and it is understood that other figures may be readily derive from these figures without inventive effort by those skilled in the art. Also, throughout the drawings, like reference numerals are used to denote like parts.

FIG. 1 is a schematic diagram of a device according to a preferred embodiment of the present invention.

FIG. 2 is a schematic diagram illustrating the ultrasonic rolling principle of the above preferred embodiment of the present invention.

FIG. 3 is a comparative graph showing the porosity of a component manufactured according to a preferred embodiment of a device and method of the present invention compared with samples subjected to interlayer ultrasonic rolling at room temperature and samples without interlayer ultrasonic rolling.

FIG. 4 is a comparative graph showing the microstructure of a component manufactured according to a preferred embodiment of a device and method of the present invention compared with samples subjected to interlayer ultrasonic rolling at room temperature and samples without interlayer ultrasonic rolling.

FIG. 5 is a comparative graph showing the tensile properties of a component manufactured according to a preferred embodiment of a device and method of the present invention compared with samples subjected to interlayer ultrasonic rolling at room temperature and samples without interlayer ultrasonic rolling.

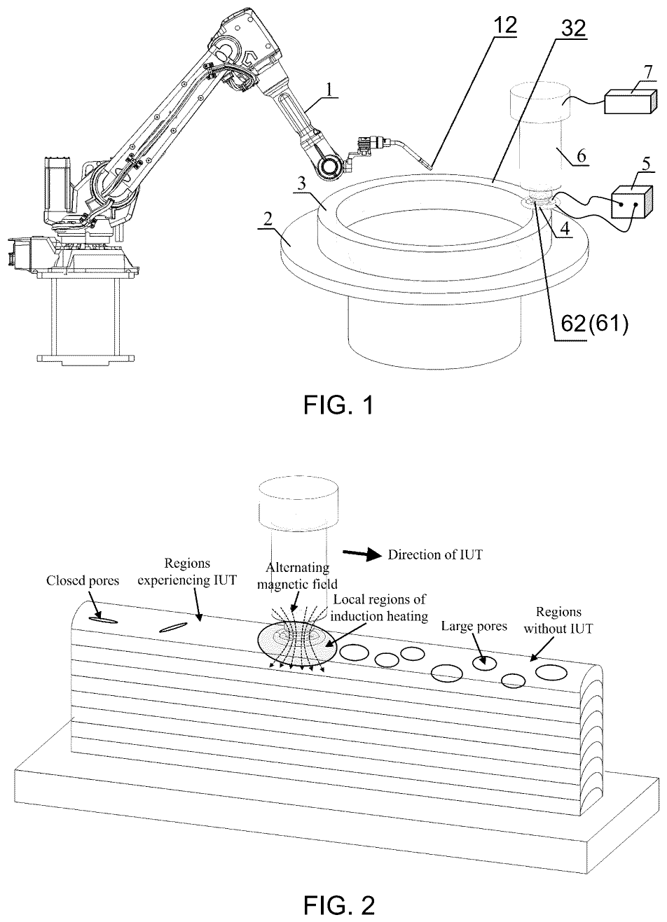

### DETAILED DESCRIPTION OF THE PREFERRED EMBODIMENT

In order to make the purpose, technical solutions and advantages of the present invention clearer, the present invention is further described in detail below with reference to the accompanying drawings and embodiments. The embodiments described herein are only used to explain the present invention and are not intended to limit the present invention.

According to a preferred embodiment of the present invention, an additive manufacturing device with interlayer ultrasonic rolling and in-situ electromagnetic induction heating includes an additive manufacturing equipment 1 for printing a component 3, a substrate turntable 2, communicating with and controlling through the additive manufacturing equipment 1, arranged for supporting and adjusting position and posture of the component 3, an ultrasonic rolling device 6 and an electromagnetic induction heating device 4 cooperated with a top 32 of the component 3 for applying a static pressure to the component 3; an ultrasonic controller 7 connected to the ultrasonic rolling device 6 to set rolling parameters required for the ultrasonic rolling device 6, and an electromagnetic controller 5 connected to the electromagnetic induction heating device 4 to set a current intensity and an induction frequency required for the electromagnetic induction heating device 4. The ultrasonic rolling device 6 is supported through a mechanical arm or a supporting frame to affix into position; and is communicating with and controlling through the additive manufacturing equipment 1. The electromagnetic induction heating device 4 is mounted around a rolling head 61 of the ultrasonic rolling device 6. The ultrasonic rolling device 6 applies a static pressure to the component 3 through the bottom 62 of the ultrasonic rolling device 6 cooperating to the top 32 of the component 3. Specifically, a rolling head 61 is provided at the bottom 62 of the ultrasonic rolling device 6.

Preferably, the additive manufacturing equipment 1 is an arc fuse additive manufacturing device, a laser directed energy deposition device, or an electron beam directed energy deposition device.

Preferably, the electromagnetic induction heating device 4 is a disc-shaped electromagnetic induction copper tube.

Preferably, the electromagnetic induction heating device 6 and the ultrasonic rolling device 4 are coaxially installed.

According to another aspect of the present invention, an additive manufacturing method with interlayer ultrasonic rolling assisted by in-situ electromagnetic induction heating includes the following steps:

Step (1): Create a 3D model of a component 3 by using a computer CAD software, and perform slicing, layering and path planning of the 3D model of the component 3 through an additive manufacturing system software of an additive manufacturing equipment 1 to obtain a preset printing path.

Step (2): Print the component 3 with the preset path layer-by-layer by a print head 12 of the additive manufacturing equipment 1, and adjust a position of the component 3 through a substrate turntable 2 to achieve printing of the preset path, wherein the component 3 may be of any shape.

Step (3): After printing one layer (namely, layer x), regulate a current and an induction frequency of an electromagnetic induction heating device 4 by an electromagnetic controller 5 so that the electromagnetic induction heating device 4 introduces a heating temperature required to an interlayer rolling area of the component 3; and set an ultrasonic power and frequency of an ultrasonic rolling device 6 by an ultrasonic controller 7 so that the ultrasonic rolling device 6 introduces a plastic deformation zone of a desired depth in the interlayer. After the parameters are set, turn on the electromagnetic induction heating device 4 and the ultrasonic rolling device 6 at the same time to perform ultrasonic rolling on a latest printed layer (namely, layer x).

Step (4): If a depth of the affected layer (namely, layer x) reaches the set range, repeat steps (2) to (3) to print subsequent layers; if the depth of the affected layer is less than the required range, continue to adjust the parameters of the ultrasonic controller 7 and the electromagnetic controller 5, and then repeat step (3) for the affected layer (namely, layer x).

Step (5): Repeat steps (2) to (4) until all the layers of the entire component 3 is printed.

It is worth mentioning that the required depth range depends on the thickness of the deposited layer and the depth of the remelting. The thicker the deposited layer or the deeper the remelting depth, the deeper the affected layer needs to be in order to retain as much of the strengthening effect as possible.

Preferred Embodiment 1: According to this embodiment, an additive manufacturing device with interlayer ultrasonic rolling assisted by in-situ electromagnetic induction heating includes an additive manufacturing equipment 1 arranged for printing a component 3, a substrate turntable 2 for supporting the component 3 so that the position and posture of the component 3 may be changed by the substrate turntable 2, an ultrasonic rolling device 6 and an electromagnetic induction heating device 4 cooperated with a top side 32 of the component 3; an ultrasonic controller 7 connected to the ultrasonic rolling device 6 to set rolling parameters required for the ultrasonic rolling device 6, wherein the rolling parameters include ultrasonic power, ultrasonic frequency and static load, an electromagnetic controller 5 connected to the electromagnetic induction heating device 4 to set a current intensity and an induction frequency required for the electromagnetic induction heating device 4.

The additive manufacturing equipment 1 is an arc fuse additive manufacturing device. The electromagnetic induction heating device 4 is a disc-shaped electromagnetic induction copper tube. The electromagnetic induction heating device 4 and the ultrasonic rolling device 6 are coaxially installed.

An additive manufacturing method by using the additive manufacturing device with interlayer ultrasonic rolling coupled with in-situ electromagnetic induction heating includes the following steps:

Step (1): Create a 3D model of the component 3 by using a computer CAD software, perform slicing, layering and path planning of the 3D model of the component 3 by using an additive manufacturing system software of the additive manufacturing equipment 1, install the ultrasonic rolling device 6 and the electromagnetic induction heating device 4 so that a bottom 62 of the ultrasonic rolling device 6 is in close contact with a top 32 of the component 3 while the electromagnetic induction heating device 4 and the ultrasonic rolling device 6 are coaxially installed, and a distance between a bottom 62 of the electromagnetic induction heating device 4 and the top 32 of the component 3 is 1 mm.

Step (2): Set an optimal process package for the material to be printed in the additive manufacturing equipment 1; and print the component 3 along a preset path in a slice data by a print head 12 of the additive manufacturing equipment 1 and adjust the position of the component 3 by the substrate turntable 2, thereby achieving seamless printing of the component 3 with any shape and without any angle restriction as long as the component 3 can withstand the statis load of the ultrasonic rolling device 6. The optimal process package takes into account both forming quality (surface quality, porosity, mechanical properties) and forming efficiency.

Step (3): After printing one layer (namely, the latest printed layer), regulate the current and the induction frequency of the electromagnetic induction heating device 4 by the electromagnetic controller 5 so that the electromagnetic induction heating device 4 introduces the temperature required to the interlayer rolling area of the component 3. Set the ultrasonic power and frequency of the ultrasonic rolling device 6 by the ultrasonic controller 7 so that the ultrasonic rolling device 6 introduces a plastic deformation zone of a desired depth in the interlayer. After the parameters of the electromagnetic induction heating device 4 and the ultrasonic rolling device 6 are set, turn on the electromagnetic induction heating device 4 and the ultrasonic rolling device 6 at the same time to perform ultrasonic rolling on the latest printed layer.

Step (4): If the depth of the affected layer (the latest printed layer) reaches the set range, repeat steps (2) to (3) to continue the printing of remaining layers; if the depth of the affected layer (the latest printed layer) is less than the required range, continue to adjust the parameters of the ultrasonic controller 7 and the electromagnetic controller 5, and then repeat step (3); and

Step (5): Repeat steps (2) to (4) until the entire component 3 is printed.

According to this embodiment, referring to FIG. 2, during the ultrasonic rolling process, the electromagnetic induction heating device 4 generates an alternating magnetic field between layers of the component 3. Under the induction of the alternating magnetic field, eddy currents are generated on the upper surface of the component 3 and resulting in electrical resistance losses. This in turn achieves the purpose of heating the material and enabling precise temperature control of the ultrasonic rolling for the part of the component 3 to be ultrasonically rolled. For metal materials with high deformation resistance, increasing the temperature during ultrasonic rolling can significantly reduce their strength, thereby increasing the depth of the plastic deformation zone. For metal materials with poor room temperature plasticity, increasing the temperature during ultrasonic rolling can significantly improve their plasticity, thereby effectively inhibiting the formation of cold cracks.

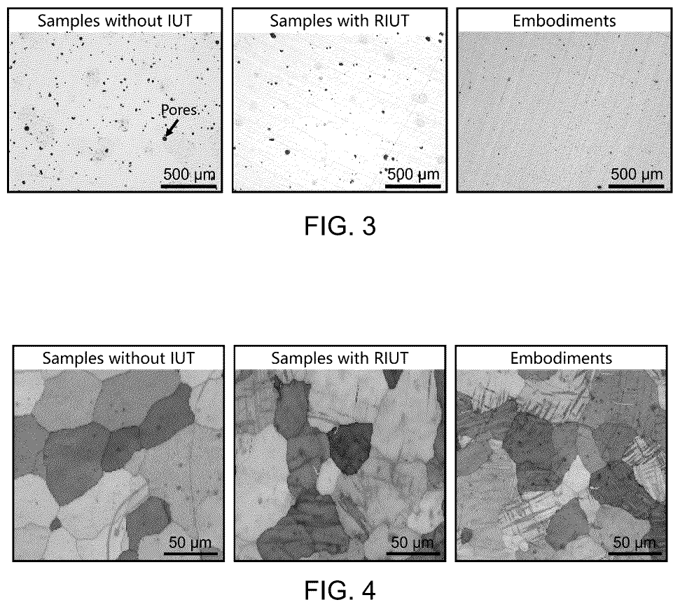

According to this embodiment, referring to FIG. 3, results of porosity measurements show that, when compared to samples without interlayer ultrasonic rolling, the solution provided by the present invention not only effectively closes metallurgical defects, but also reduces defect content by 66%. Compared with the samples subjected to interlayer ultrasonic rolling at room temperature, the solution provided by the present invention can further eliminate defects, and the density is increased by 24%.

According to this embodiment, referring to FIG. 4, the microstructure shows that, when compared to samples without interlayer ultrasonic rolling, deformation twins and dislocations can be introduced into the component by adopting the solution of the present invention. Compared with the samples subjected to interlayer ultrasonic rolling at room temperature, the solution provided by the present invention can form higher density deformation twins and dislocations, and the strengthening effect is more significant.

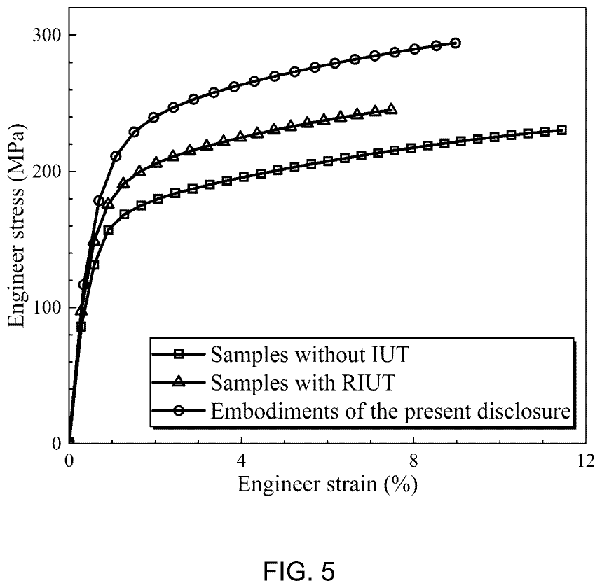

According to this embodiment, referring to FIG. 5, the tensile performance test results show that, when compared to samples without interlayer ultrasonic rolling, the solution provided by the present invention can greatly improve the strength, with the yield strength and tensile strength increased by 38% and 21% respectively. Compared with samples subjected to interlayer ultrasonic rolling at room temperature, the solution of the present invention can synergistically improve strength and plasticity, with yield strength, tensile strength and elongation increased by 19%, 17% and 20% respectively.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An additive manufacturing device with interlayer ultrasonic rolling and in-situ electromagnetic induction heating, characterized in that, comprising:
an additive manufacturing equipment (1) arranged for printing a component (3);
a substrate turntable (2), communicating and controlled through said additive manufacturing equipment (1), supporting the component (3) to adjust the position of the component (3);
an ultrasonic rolling device (6) and an electromagnetic induction heating device (4) cooperated with a top (32) of the component (3),
an ultrasonic controller (7) connected to said ultrasonic rolling device (6) to set rolling parameters required for said ultrasonic rolling device (6), wherein the rolling parameters include ultrasonic power, ultrasonic frequency and static load; and
an electromagnetic controller (5) connected to said electromagnetic induction heating device (4) to set a current intensity and an induction frequency required for said electromagnetic induction heating device (4).

2. The additive manufacturing device with interlayer ultrasonic rolling coupled in-situ electromagnetic induction heating according to claim 1, said additive manufacturing equipment (1) is an arc fuse additive manufacturing device, a laser directed energy deposition device, or an electron beam directed energy deposition device.

3. The additive manufacturing device with interlayer ultrasonic rolling coupled in-situ electromagnetic induction heating according to claim 2, characterized in that, said electromagnetic induction heating device (4) is a disc-shaped electromagnetic induction copper tube.

4. The additive manufacturing device with interlayer ultrasonic rolling coupled in-situ electromagnetic induction heating according to claim 2, characterized in that, said electromagnetic induction heating device (4) and said ultrasonic rolling device (6) are coaxially installed.

5. An additive manufacturing method by said additive manufacturing device with interlayer ultrasonic rolling coupled in-situ electromagnetic induction heating according to claim 1, characterized in that, said method comprises the steps of:
step (a): creating a 3D model of a component by using a computer CAD software, and performing slicing, layering and path planning of the 3D model of the component through an additive manufacturing system software to obtain a preset printing path;
step (b): printing the component along the preset path by a print head of said additive manufacturing equipment, and adjust a position of the component through said substrate turntable to achieve printing of the component, which may be of any shape;
step (c): after printing one layer, regulating a current and an induction frequency of said electromagnetic induction heating device by said electromagnetic controller so that said electromagnetic induction heating device introduces a heating temperature required to an interlayer rolling area of the component; and setting an ultrasonic power and frequency of said ultrasonic rolling device (6) by said ultrasonic controller (7) so that said ultrasonic rolling device introduces a plastic deformation zone of a desired depth in the interlayer; after the parameters are set, turning on said electromagnetic induction heating device and said ultrasonic rolling device simultaneously to perform ultrasonic rolling on the latest printed layer;
step (d): performing step (c) by adjusting the parameters of said ultrasonic controller and said electromagnetic controller for the printed layer if a depth of the printed layer is less than the required range, and performing steps (b) to (c) to print subsequent layers if the depth of the printed layer reaches the required range; and
step (e): performing steps (b) to (d) until the entire component (3) is printed.

6. An additive manufacturing method by said additive manufacturing device with interlayer ultrasonic rolling coupled in-situ electromagnetic induction heating according to claim 2, characterized in that, said method comprises the steps of:
step (a): creating a 3D model of a component by using a computer CAD software, and performing slicing, layering and path planning of the 3D model of the component through an additive manufacturing system software to obtain a preset printing path;
step (b): printing the component along the preset path by a print head of said additive manufacturing equipment, and adjust a position of the component through said substrate turntable to achieve printing of the component, which may be of any shape;
step (c): after printing one layer, regulating a current and an induction frequency of said electromagnetic induction heating device by said electromagnetic controller so that said electromagnetic induction heating device introduces a heating temperature required to an interlayer rolling area of the component; and setting an ultrasonic power and frequency of said ultrasonic rolling device (6) by said ultrasonic controller (7) so that said ultrasonic rolling device introduces a plastic deformation zone of a desired depth in the interlayer; after the parameters are set, turning on said electromagnetic induction heating device and said ultrasonic rolling device simultaneously to perform ultrasonic rolling on the latest printed layer;
step (d): performing step (c) by adjusting the parameters of said ultrasonic controller and said electromagnetic controller for the printed layer if a depth of the printed layer is less than the required range, and performing steps (b) to (c) to print subsequent layers if the depth of the printed layer reaches the required range; and
step (e): performing steps (b) to (d) until the entire component (3) is printed.

7. An additive manufacturing method by said additive manufacturing device with interlayer ultrasonic rolling coupled in-situ electromagnetic induction heating according to claim 3, characterized in that, said method comprises the steps of:
step (a): creating a 3D model of a component by using a computer CAD software, and performing slicing, layering and path planning of the 3D model of the component through an additive manufacturing system software to obtain a preset printing path;
step (b): printing the component along the preset path by a print head of said additive manufacturing equipment, and adjust a position of the component through said substrate turntable to achieve printing of the component, which may be of any shape;
step (c): after printing one layer, regulating a current and an induction frequency of said electromagnetic induction heating device by said electromagnetic controller so that said electromagnetic induction heating device introduces a heating temperature required to an interlayer rolling area of the component; and setting an ultrasonic power and frequency of said ultrasonic rolling device (6) by said ultrasonic controller (7) so that said ultrasonic rolling device introduces a plastic deformation zone of a desired depth in the interlayer; after the parameters are set, turning on said electromagnetic induction heating device and said ultrasonic rolling device simultaneously to perform ultrasonic rolling on the latest printed layer;
step (d): performing step (c) by adjusting the parameters of said ultrasonic controller and said electromagnetic controller for the printed layer if a depth of the printed layer is less than the required range, and performing steps (b) to (c) to print subsequent layers if the depth of the printed layer reaches the required range; and
step (e): performing steps (b) to (d) until the entire component (3) is printed.

8. An additive manufacturing method by said additive manufacturing device with interlayer ultrasonic rolling coupled in-situ electromagnetic induction heating according to claim 4, characterized in that, said method comprises the steps of:
step (a): creating a 3D model of a component with a computer software, and performing slicing, layering and path planning of the 3D model of the component through an additive manufacturing system software of said additive manufacturing equipment (1) to obtain a preset layer-by-layer printing path;
step (b): printing the component (3) layer by layer along the preset layer-by-layer path by a print head of said additive manufacturing equipment, and adjust a position of the component through said substrate turntable to achieve printing of the component (3);
step (c): after printing one layer (the latest printed layer), regulating a current and an induction frequency of said electromagnetic induction heating device by said electromagnetic controller so that said electromagnetic induction heating device introduces a heating temperature required to an interlayer rolling area of the component; and setting an ultrasonic power and frequency of said ultrasonic rolling device (6) by said ultrasonic controller (7) so that said ultrasonic rolling device introduces a plastic deformation zone of a desired depth in the interlayer; after the parameters are set, turning on said electromagnetic induction heating device and said ultrasonic rolling device simultaneously to perform ultrasonic rolling on the latest printed layer;
step (d): performing step (c) by adjusting the parameters of said ultrasonic controller and said electromagnetic controller for the latest printed layer if a depth of the latest printed layer is less than the required range, and performing steps (b) to (c) to print subsequent layers if the depth of the latest printed layer reaches the required range; and
step (e): performing steps (b) to (d) until the entire component (3) is printed.

9. An additive manufacturing device with interlayer ultrasonic rolling and in-situ electromagnetic induction heating, characterized in that, comprising:
an additive manufacturing equipment (1) arranged for printing a component (3);
a substrate turntable (2), communicating and controlled through said additive manufacturing equipment (1), supporting the component (3) to adjust the position of the component (3);
an ultrasonic rolling device (6) mounted at a position to apply a static pressure to a top (32) of the component (3),
an electromagnetic induction heating device (4) coaxially mounted to a bottom of said ultrasonic rolling device (6), cooperated with said top (32) of the component (3),
an ultrasonic controller (7) connected to said ultrasonic rolling device (6) to set rolling parameters required for said ultrasonic rolling device (6), wherein the rolling parameters include ultrasonic power, ultrasonic frequency and static load; and
an electromagnetic controller (5) connected to said electromagnetic induction heating device (4) to set a current intensity and an induction frequency required for said electromagnetic induction heating device (4).
